(19) United States
(12) Patent Application Publication
(10) Pub. No.: US 2026/0127114 A1
(43) Pub. Date: May 7, 2026

(54) FAULT CONDITION WRITEBACK

(71) Applicant: Infineon Technologies AG, Neubiberg (DE)

(72) Inventor: Max BRAND, Unterhaching (DE)

(21) Appl. No.: 19/317,824

(22) Filed: Sep. 3, 2025

(30) Foreign Application Priority Data
Nov. 4, 2024 (DE) 102024210557.0

(51) Int. Cl. G06F 12/0804; G06F 1/28; G06F 1/30

(52) U.S. Cl. CPC G06F 12/0804; G06F 1/28; G06F 1/30

(57) ABSTRACT

An electronic device is presented. The electronic device comprises a non-volatile memory configured for storing information independent of power supply. The electronic device further comprises a plurality of writeback registers configured for storing information parallel to operation of the electronic device. The electronic device further comprises a fault condition detector configured for detecting a fault condition of a primary power supply, activating a substitute power supply path to a substitute power supply in case of the fault condition, and initiating an information transfer from the writeback registers to the non-volatile memory in case of the fault condition. Further, a system comprising the electronic device and a method for operating the electronic device are presented.

### TECHNICAL FIELD

The present disclosure relates to an electronic device, a system and a method. The electronic device, the system and the method may specifically be used for automotive applications, such as for controlling a vehicle or at least a part thereof. However, other applications may in principle of course also be feasible.

### BACKGROUND

In practice, electronic devices may suffer from fault conditions during operation, such as from a power supply failure. Electronic devices typically need to store diagnostic information on such events, such as for later analysis. It is further typically required that this is done immediately, e.g. due to loss of power supply, or generally to avoid data loss. However, an application controlled by the electronic device typically also needs to continue operation, at least in a special operation mode. As an example, the application controlled by the electronic device may be brought into a safe state, which may be an off state, such as by using a soft shut down. For immediately storing the information while continuing operation of the application, read-while-write memory architectures are typically required. Normally, when a memory is busy with a write operation, a read operation is not possible. However, if a system cannot retrieve and execute a subsequent instruction, this may significantly disturb the overall performance. Read-while-write memories may allow reading and writing concurrently. Such read-while-write memories may be implemented by using multi-bank devices, such as multi-bank NOR flash devices. Then, in a first bank, a write operation may be performed, while, in a second bank, a read operation may be performed. However, such devices are typically rather expensive. Thus, there is specifically a need for reducing costs while still ensuring adequate fault condition handling.

### SUMMARY

In a first aspect, an electronic device is presented. The electronic device comprises a non-volatile memory. The non-volatile memory is configured for storing information independent of power supply. The electronic device further comprises a plurality of writeback registers. The writeback registers are configured for storing information parallel to operation of the electronic device. The electronic device further comprises a fault condition detector. The fault condition detector is configured for detecting a fault condition of a primary power supply. The fault condition detector is further configured for activating a substitute power supply path to a substitute power supply in case of the fault condition. The fault condition detector is further configured for initiating an information transfer from the writeback registers to the non-volatile memory in case of the fault condition.

In a further aspect, a system is presented. The system comprises a substitute power supply. The system further comprises an electronic device. The electronic device comprises a non-volatile memory. The non-volatile memory is configured for storing information independent of power supply. The electronic device further comprises a plurality of writeback registers. The writeback registers are configured for storing information parallel to operation of the electronic device. The electronic device further comprises a fault condition detector. The fault condition detector is configured for detecting a fault condition of a primary power supply. The fault condition detector is further configured for activating a substitute power supply path to a substitute power supply in case of the fault condition. The fault condition detector is further configured for initiating an information transfer from the writeback registers to the non-volatile memory in case of the fault condition.

In a further aspect, a method is presented. The method comprises:
a) storing information in a writeback register of an electronic device parallel to operation of the electronic device,
b) detecting a fault condition of a primary power supply,
c) activating a substitute power supply path to a substitute power supply,
d) initiating an information transfer from the writeback register to a non-volatile memory of the electronic device.

In a further aspect, a use of the electronic device, the system and/or the method for an automotive application is presented.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 schematically illustrates an example of a system comprising an electronic device according to the present disclosure.

FIG. 2 schematically illustrates a further example of a system comprising an electronic device according to the present disclosure.

FIG. 3 schematically illustrates a flow chart of an example of a method according to the present disclosure.

### DETAILED DESCRIPTION

The examples described herein provide considerable advantages. In parallel to normal operation, information may be stored in the writeback registers of the presented electronic device. In case of a power supply failure, the fault condition detector of the presented electronic device may then at least temporarily facilitate further operation by accessing a substitute power supply, e.g. a capacitor charged by a primary power supply during normal operation. In this further operation, the information stored in the writeback registers may be transferred to the

non-volatile memory of the presented electronic device for long-term storage without further power supply. Thus, expensive read-while-write memory architectures may specifically be avoided.

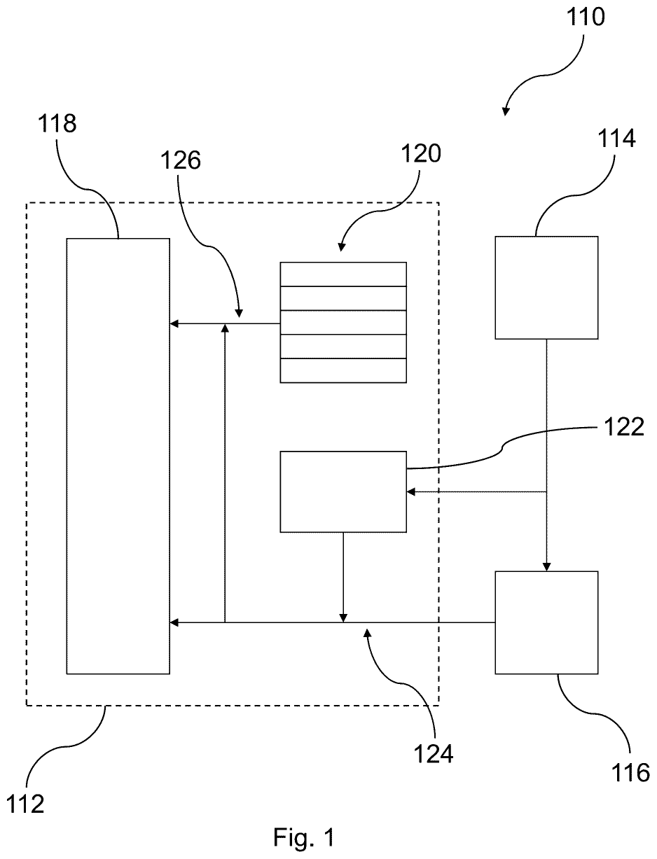

FIG. 1 schematically illustrates an example of system 110 comprising an electronic device 112. The electronic device 112 may be configured for controlling an application, specifically an automotive application. As an example, the application may be or may comprise an actuator or a sensor or a lighting device or a switch in a vehicle. The system 110 may comprise a primary power supply 114. As an example, the primary power supply 114 may be a battery, such as a

battery of a vehicle. The system 110 comprises a substitute power supply 116. As an example, the substitute power supply 116 may be a capacitor. Specifically, the capacitor may be arranged such that the capacitor is charged by the primary power supply 114 during operation of the electronic device 112. The primary power supply 114 and the substitute power supply 116 may be configured for supplying the electronic device 112 with equal power, e.g. 48 V. The capacitor may be configured for at least temporarily supplying the electronic device 112 with such power. The primary power supply 114 may be external to the electronic device 112. The substitute power supply 116 may also be external to the electronic device 112. In other words, the primary power supply 114 and the substitute power supply 116 may not be part of the electronic device 112. The electronic device 112 may be a semiconductor device 112. As an

example, the electronic device 112 may be an integrated circuit or may comprise one or more integrated circuits, which may for instance be arranged on a printed circuit board.

The electronic device 112 comprises a non-volatile memory 118. The non-volatile memory 118 is configured for storing information independent of power supply. Thus, even if the primary power supply 114 and/or the substitute power supply 116 may not supply the electronic device 112 with power, the non-volatile memory 118 may still store the information. As an example, the non-volatile memory 118 may be selected from the group consisting of a flash memory, a non-volatile random-access memory, an erasable programmable read-only memory. Other options may however also be feasible. The information may specifically be or may comprise diagnostic information on the operation of the electronic device 112 and/or on an application controlled by the electronic device 112. More specifically, the diagnostic information may comprise information on at least one of a temperature of the electronic device 112 or at least a part thereof, a voltage supplied to the electronic device 112, operating hours of the electronic device 112, a time stamp, a power consumption of the electronic device 112 and an application-specific status of the electronic device 112. Again, other options may also be feasible. The application-specific status may refer to a status set at an application controlled by the electronic device 112.

The electronic device 112 further comprises a plurality of writeback registers 120. The writeback registers 120 are configured for storing information parallel to operation of the electronic device 112. In other words, the writeback registers 120 may be registers configured for writing back or for directly storing information when executing an instruction during operation of the electronic device 112. Such a writeback operation may specifically be performed in an immediate and quick fashion. Thus, the writeback registers 120 may be quickly accessible. As an example, the electronic device 112 may execute instructions for controlling an application and directly store information, such as a result of the execution, in the writeback registers 120. The electronic device 112 may for instance execute a regulation operation or a sense operation at a controlled application and directly store corresponding diagnostic information such as an application-specific status in the writeback registers 120. The writeback registers 120 may be buffers. Specifically, the writeback registers 120 may be buffers for storing the information until the information is stored in another storage device, specifically in the non-volatile memory 118. In other words, the writeback registers 120 may be intermediate storage devices. As an example, the writeback registers 120 may form a cache or may be part of a cache. Other options may however also be feasible.

The electronic device 112 further comprises a fault condition detector 122. The fault condition may for instance be an undervoltage condition, an overvoltage condition or an overtemperature condition. Other options may also be feasible. Thus, the fault condition may be a deviation from a normal condition. The normal condition may for instance be a power supply with a predefined voltage, e.g. 48 V. Thus, the fault condition may for instance be a power supply with a different or at least with a significantly different voltage, such as a voltage that exceeds a predefined threshold voltage. The fault condition may comprise a failure or malfunctioning of the electronic

device 112 or at least a part thereof or a failure or malfunctioning of a device external to the electronic device 112, specifically of the primary power supply 114. The fault condition may comprise a failure event, e.g. a failure or malfunction of the primary power supply 114. As an example, there may be a fault condition of the primary power supply 114 if a supplied voltage decreases below a predefined threshold voltage. The fault condition detector 122 is configured for detecting a fault condition of the primary power supply 114. Thus, the fault condition detector 122 may be configured for observing or sensing at least the primary power supply 114. The fault condition detector 122 may also be configured for observing or sensing further components such as the electronic device 112 or at least a part thereof and/or the substitute power supply 116. The fault condition detector 122 may for instance comprise at least one of a voltage detector, a temperature detector and a current detector. Other options may also be feasible.

The fault condition detector 122 is further configured for activating a substitute power supply path 124 to the substitute power supply 116 in case of the fault condition. The substitute power supply path 124 may be or may comprise a connection to the substitute power supply 116, specifically a wired connection. Thus, the substitute power supply path 124 may be or may comprise a wire and or a trace. Thus, the fault condition detector 122 may be configured for connecting the substitute power supply 116 to the electronic device 112 or at least to a part thereof. The fault condition detector 122 may further be configured for disconnecting the primary power supply 114. The fault condition detector 122 may for instance comprise a switching element for such purposes. The fault condition detector 122 may also be configured for disconnecting or disabling components of the electronic device 112, specifically components which are not necessarily required for operation of the electronic device 112. Thus, power may be saved for essential components. In case of the fault condition, the electronic device 112 may operate under restriction and not with full functionality. The substitute power supply 116 may only be configured for supplying the electronic device 112 with power over a limited period of time in the fault condition. This may require sufficient power management and prioritization of certain processes such as adequate information storage before an end of power supply.

The fault condition detector 122 is further configured for initiating an information transfer 126 from the writeback registers 120 to the non-volatile memory 118 in case of the fault condition. In other words, the fault condition detector 122 may be configured for triggering or initializing the information transfer 126. Further components may be involved in implementing the information transfer 126 as will also be outlined in further detail below. However, as indicated, the fault condition detector 122 may detect the fault condition and this may start further measures for implementing the information transfer 126 optionally involving further components. The information transfer 126 may comprise writing the information stored in the writeback registers 120 in the non-volatile memory 118. The information may specifically be represented as data. Thus, as will also be outlined in further detail below, the information transfer 126 may comprise writing data stored in the writeback registers 120 in predefined addresses in the non-volatile memory 118. The addresses may again also be stored in the writeback registers 120, specifically in other writeback registers 120 which are not storing the above-mentioned data. The data may specifically be digital data. Thus, the information transfer 126 may be or may comprise a data transfer and specifically a digital data transfer, such as over a data line.

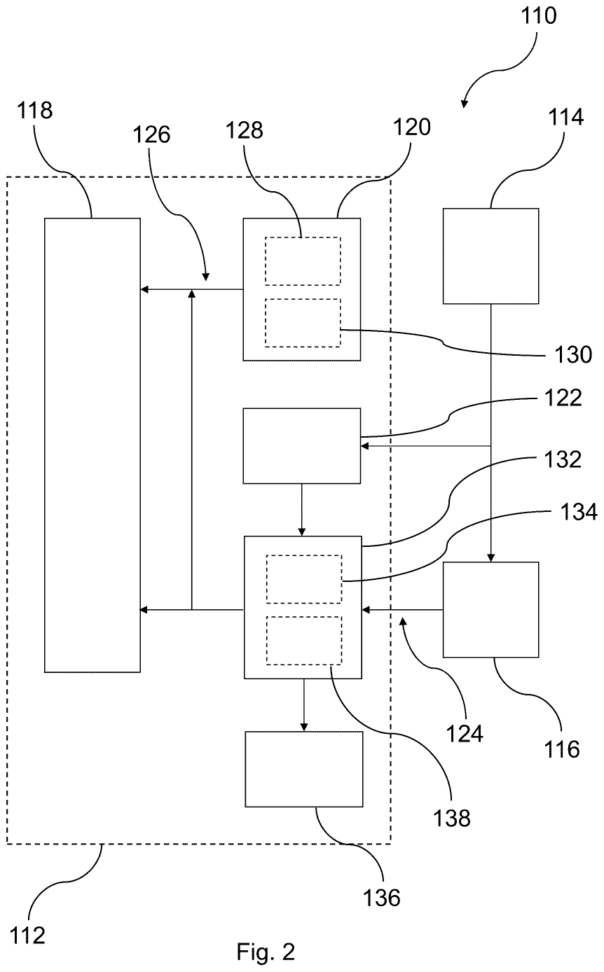

FIG. 2 schematically illustrates a further example of the system 110 comprising the electronic device 112. At least in many aspects, the system 110 illustrated in FIG. 2 corresponds to the system 110 illustrated in FIG. 1. Thus, at least in many aspects, reference may be made to the description of FIG. 1 above when describing FIG. 2, which shall not be repeated again in the following. As FIG. 2 shows, the writeback registers 120 may specifically comprise at least one writeback data register 128 and at least one writeback address register 130. The writeback data register 128 may be configured for storing data. The writeback address register 130 may be configured for storing addresses. Thus, the information transfer 126 may comprise transferring the data stored in the writeback data register 128 to an address in the non-volatile memory 118, wherein the address is stored in the writeback address register 130.

As FIG. 2 further shows, the electronic device 112 may comprise a controller 132. The controller 132 may be arranged in the substitute power supply path 126. The controller 132 may be configured for controlling or managing at least the information transfer 126 from the writeback registers 120 to the non-volatile memory 118. Thus, the controller 132 may comprise a state machine 134. The state machine 134 may be configured for processing predefined states for further operation of the electronic device 112 in case of the fault condition, specifically in a step-by-step fashion. The state machine 134 may specifically be a finite state machine. Thus, the state machine 134 may comprise a number of states, specifically a finite number of states, and may be configured for transitioning from one state to another. A transition may be triggered by an input such as an external event. The state machine 134 may generate an output depending on the present state.

The state machine 134 may be activated in case of the fault condition, specifically by the fault condition detector 122. The state machine 134 may specifically comprise the states described in the following. A first state may comprise disabling not required components of the electronic device 112, such as components which do not fulfill safety-critical tasks or such as components which are not required for the information transfer 126. As an example, the fault condition detector 122 may be disabled in this state, since the fault condition was already detected such that no further observation is required. Thus, the controller 132 may also be configured for disabling one or more components of the electronic device 112. As FIG. 2 shows, the electronic device 112 may further comprise at least one application-specific component 136, e.g. a sensor or an actuator or a lighting device or a switch. Thus, the controller 132 may be configured for disabling the application-specific component 136 in case of the fault condition, specifically in case the application-specific component is not safety-critical. A further state may comprise ensuring power supply of the required components, e.g. of the non-volatile memory 118, such as by connecting the electronic device 112 to the substitute power supply 116. A further state may comprise performing the information transfer 126 from the writeback registers 120 to the non-volatile memory 118. A completion of a previous task may trigger a transition of the state machine 134 to the subsequent state.

Additionally or alternatively, the controller 132 may comprise an adapter 138. The adapter 138 may be configured for adapting or managing power supplied by the substitute power supply 116. As already indicated, the substitute power supply 116 may specifically be a capacitor. Thus, the adapter 138 may specifically be configured for adapting power provided by the capacitor. As an example, the capacitor may be a 48 V capacitor. Internal logic components of the electronic device 112 may however require significantly lower voltages. As an example, the non-volatile memory 118 may require 3 V for operation. Thus, the adapter 138 may specifically be or may comprise a voltage converter. Further, as also already indicated, the substitute power supply 116 may only be configured for supplying the electronic device 112 or at least parts thereof with power over a limited period of time. Thus, the adapter 138 may be configured for monitoring a status of the substitute power supply 116, specifically such that the controller 132 can disable or enable selected components of the electronic device 112 according to the remaining power which is still available.

Overall, during normal operation, the primary power supply 114 may supply power to the electronic device 112. However, in case of a fault condition of the primary power supply 114, e.g. a supply with a voltage below a predefined threshold, this may be detected by the fault condition detector 122, which may trigger further actions. The fault condition detector 122 may activate a substitute power supply path 124 from the electronic device 112 to the substitute power supply 116, e.g. a capacitor charged by the primary power supply during normal operation. Specifically, the fault condition detector 122 may activate the controller 132 comprising the state machine 134 and the adapter 138. According to the sequence predefined in the state machine 134, the controller 132 may disable selected components of the electronic device 112, such as the fault condition detector 122 or the application-specific component 136, specifically in case the application-specific component 136 does not perform a safety-critical task. Further, the controller 132 may ensure sufficient further power supply, at least over a limited period of time. Specifically, the adapter 136 may adapt a power supplied to the electronic device 112 from the substitute power supply 116 according to the requirements of the still active components of the electronic device 112. Further, the controller 132 may manage the information transfer 126 from the writeback registers 120 to the non-volatile memory 118, such that the information is safely stored power independently.

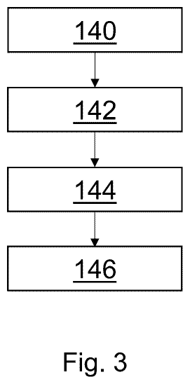

FIG. 3 illustrates a flow chart of an example of a method for implementing the above-mentioned procedure. The method comprises the following method steps. The presented method steps may be performed in the indicated order. It shall be noted, however, that a different order may also be possible. The method may comprise further method steps which are not listed. Further, one or more of the method steps may be performed once or repeatedly. Further, two or more of the method steps may be performed simultaneously or in a timely overlapping fashion. The method may at least partially be computer implemented. Thus, one or more of the following method steps may be computer implemented.
a) (denoted by reference numeral 140) storing information in a writeback register 120 of the electronic device 112 parallel to operation of the electronic device 112,
b) (denoted by reference numeral 142) detecting a fault condition of a primary power supply 114,
c) (denoted by reference numeral 144) activating a substitute power supply path 124 to a substitute power supply 116,
d) (denoted by reference numeral 146) initiating an information transfer 126 from the writeback register 120 to a non-volatile memory 118 of the electronic device 112.

Specifically, step d) may be prioritized during a remaining operation of the electronic device 112. Thus, other processes may be disabled in order to safely perform the information transfer 126 with the remaining power from the substitute power source 116. Not required components of the electronic device 112 may specifically be disabled as outlined in further detail above, such that the remaining power can be used for the information transfer 126. As also already indicated, step d) may specifically comprise transferring data stored in a writeback data register 128 to an address in the non-volatile memory 118 stored in a writeback address register 130. For further details regarding the method, method may also be made to the description of the system 110 and the electronic device 112 FIGS. 1 and 2 above. The system 110, the electronic device 112 and/or the described method may specifically be used in an automotive application. Thus, they may be used for controlling an application in a vehicle, such as an actuator or a sensor or a lighting device or a switch in a vehicle.

In addition to the above-mentioned examples, the following examples are disclosed herein:

Example 1: An electronic device comprising:
a non-volatile memory configured for storing information independent of power supply,
a plurality of writeback registers configured for storing information parallel to operation of the electronic device, and
a fault condition detector configured for:
   detecting a fault condition of a primary power supply,
   activating a substitute power supply path to a substitute power supply in case of the fault condition, and
   initiating an information transfer from the writeback registers to the non-volatile memory in case of the fault condition.
Example 2: The electronic device according to the preceding Example, wherein the fault condition is selected from the group consisting of: an undervoltage condition, an overvoltage condition, an overtemperature condition.

Example 3: The electronic device according to any one of the preceding Examples, further comprising:
a controller in the substitute power supply path, wherein the controller is configured for controlling the information transfer from the writeback registers to the non-volatile memory.
Example 4: The electronic device according to the preceding Example, wherein the controller comprises a state machine, wherein the state machine is configured for step-by-step processing predefined states for further operation of the electronic device in case of the fault condition.

Example 5: The electronic device according to any one of the two preceding Examples, wherein the controller is further configured for disabling one or more components of the electronic device.

Example 6: The electronic device according to the preceding Example, wherein the electronic device further comprises at least one application-specific component, wherein the controller is configured for disabling the application-specific component in case of the fault condition.

Example 7: The electronic device according to any one of the four preceding Examples, wherein the controller further comprises an adapter configured for adapting power supplied by the substitute power supply.

Example 8: The electronic device according to the preceding Example, wherein the substitute power supply is a capacitor, wherein the adapter is configured for adapting power provided by the capacitor.

Example 9: The electronic device according to any one of the preceding Examples, wherein the non-volatile memory is selected from the group consisting of: a flash memory, a non-volatile random-access memory, an erasable programmable read-only memory.

Example 10: The electronic device according to any one of the preceding Examples, wherein the information stored in the writeback registers parallel to the operation of the electronic device and transferred to the non-volatile memory in case of the fault condition comprises diagnostic information on the operation of the electronic device.

Example 11: The electronic device according to the preceding Example, wherein the diagnostic information comprises information on at least one of: a temperature of the electronic device or at least a part thereof, a voltage supplied to the electronic device, operating hours of the electronic device, a time stamp, a power consumption of the electronic device, an application-specific status of the electronic device.

Example 12: The electronic device according to any one of the preceding Examples, wherein the writeback registers comprise:
at least one writeback data register configured for storing data, and
at least one writeback address register configured for storing addresses.

Example 13: The electronic device according to the preceding Example, wherein the information transfer comprises transferring the data stored in the writeback data register to an address in the non-volatile memory, wherein the address is stored in the writeback address register.

Example 14: The electronic device according to any one of the preceding Examples, wherein the electronic device is a semiconductor device.

Example 15: A system comprising a substitute power supply and an electronic device, wherein the electronic device comprises:
a non-volatile memory configured for storing information independent of power supply,
a plurality of writeback registers configured for storing information parallel to operation of the electronic device, and
a fault condition detector configured for:
   detecting a fault condition of a primary power supply,
   activating a substitute power supply path to the substitute power supply in case of the fault condition, and
   initiating an information transfer from the writeback registers to the non-volatile memory in case of the fault condition.

Example 16: The system according to the preceding Example, wherein the electronic device is an electronic device according to any one of the preceding Examples referring to an electronic device.

Example 17: The system according to any one of the preceding system Examples, wherein the substitute power supply is a capacitor.

Example 18: The system according to the preceding Example, wherein the capacitor is arranged such that the capacitor is charged by the primary power supply during operation of the electronic device.

Example 19: The system according to any one of the preceding system Examples, further comprising the primary power supply.

Example 20: The system according to the preceding Example, wherein the primary power supply and the substitute power supply are configured for supplying the electronic device with equal power.

Example 21: The system according to any one of the two preceding Examples, wherein the primary power supply is a battery.

Example 22: A method comprising:
a) storing information in a writeback register of an electronic device parallel to operation of the electronic device,
b) detecting a fault condition of a primary power supply,
c) activating a substitute power supply path to a substitute power supply,
d) initiating an information transfer from the writeback register to a non-volatile memory of the electronic device.

Example 23: The method according to the preceding Example, wherein the electronic device is an electronic device according to any one of the preceding Examples referring to an electronic device.

Example 24: The method according to any one of the preceding method Examples, wherein step d) is prioritized during a remaining operation of the electronic device.

Example 25: The method according to any one of the preceding method Examples, wherein step d) comprises transferring data stored in a writeback data register to an address in the non-volatile memory stored in a writeback address register.

Example 26: The method according to any one of the preceding method Examples, wherein the method is at least partially computer implemented.

Example 27: A use for an automotive application of at least one of an electronic device according to any one of the preceding Examples referring to an electronic device, a system according to any one of the preceding system Examples and a method according to any one of the preceding method Examples.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the disclosure and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the disclosure, as well as specific examples thereof, are intended to encompass equivalents thereof.

1. An electronic device comprising:
a non-volatile memory configured for storing information independent of power supply,
a plurality of writeback registers configured for storing information parallel to operation of the electronic device, and
a fault condition detector configured for:
detecting a fault condition of a primary power supply,
activating a substitute power supply path to a substitute power supply in case of the fault condition, and
initiating an information transfer from the writeback registers to the non-volatile memory in case of the fault condition.

2. The electronic device of claim 1, wherein the fault condition is selected from the group consisting of: an undervoltage condition, an overvoltage condition, an overtemperature condition.

3. The electronic device of claim 1, further comprising:
a controller in the substitute power supply path, wherein the controller is configured for controlling the information transfer from the writeback registers to the non-volatile memory.

4. The electronic device of claim 3, wherein the controller comprises a state machine, wherein the state machine is configured for step-by-step processing predefined states for further operation of the electronic device in case of the fault condition.

5. The electronic device of claim 3, wherein the controller is further configured for disabling one or more components of the electronic device.

6. The electronic device of claim 5, wherein the electronic device further comprises at least one application-specific component, wherein the controller is configured for disabling the application-specific component in case of the fault condition.

7. The electronic device of claim 3, wherein the controller further comprises an adapter configured for adapting power supplied by the substitute power supply.

8. The electronic device of claim 7, wherein the substitute power supply is a capacitor, wherein the adapter is configured for adapting power provided by the capacitor.

9. The electronic device of claim 1, wherein the information stored in the writeback registers parallel to the operation of the electronic device and transferred to the non-volatile memory in case of the fault condition comprises diagnostic information on the operation of the electronic device.

10. The electronic device of claim 9, wherein the diagnostic information comprises information on at least one of: a temperature of the electronic device or at least a part thereof, a voltage supplied to the electronic device, operating hours of the electronic device, a time stamp, a power consumption of the electronic device, an application-specific status of the electronic device.

11. The electronic device of claim 1, wherein the writeback registers comprise:
at least one writeback data register configured for storing data, and
at least one writeback address register configured for storing addresses.

12. The electronic device of claim 11, wherein the information transfer comprises transferring the data stored in the writeback data register to an address in the non-volatile memory, wherein the address is stored in the writeback address register.

13. A system comprising a substitute power supply and an electronic device, wherein the electronic device comprises:
a non-volatile memory configured for storing information independent of power supply,
a plurality of writeback registers configured for storing information parallel to operation of the electronic device, and
a fault condition detector configured for:
detecting a fault condition of a primary power supply,
activating a substitute power supply path to the substitute power supply in case of the fault condition, and
initiating an information transfer from the writeback registers to the non-volatile memory in case of the fault condition.

14. The system according claim 13, wherein the substitute power supply is a capacitor.

15. The system of claim 14, wherein the capacitor is arranged such that the capacitor is charged by the primary power supply during operation of the electronic device.

16. The system of claim 13, further comprising the primary power supply.

17. The system of claim 16, wherein the primary power supply and the substitute power supply are configured for supplying the electronic device with equal power.

18. A method comprising:
a) storing information in a writeback register of an electronic device parallel to operation of the electronic device,
b) detecting a fault condition of a primary power supply,
c) activating a substitute power supply path to a substitute power supply,
d) initiating an information transfer from the writeback register to a non-volatile memory of the electronic device.

19. The method of claim 18, wherein step d) is prioritized during a remaining operation of the electronic device.

20. The method of claim 18, wherein the method is used for an automotive application.
